(19) United States
(12) Patent Application Publication
(10) Pub. No.: US 2018/0268816 A1
(43) Pub. Date: Sep. 20, 2018

(54) GENERATING DEVICE, GENERATING METHOD, AND NON-TRANSITORY COMPUTER READABLE STORAGE MEDIUM

(71) Applicant: YAHOO JAPAN CORPORATION, Tokyo (JP)

(72) Inventors: Shunpei SANO, Tokyo (JP); Nobuhiro KAJI, Tokyo (JP); Manabu SASSANO, Tokyo (JP)

(73) Assignee: YAHOO JAPAN CORPORATION, Tokyo (JP)

(21) Appl. No.: 15/890,666

(22) Filed: Feb. 7, 2018

(30) Foreign Application Priority Data
Mar. 17, 2017 (JP) 2017-052981

(51) Int. Cl. G10L 15/22; G10L 13/00; G10L 15/02; G10L 15/04

(52) U.S. Cl. CPC G10L 15/22; G10L 13/00; G10L 15/16; G10L 15/04; G10L 15/02

(57) ABSTRACT

A generating device includes an accepting unit that accepts a speech of a user. The generating device includes a generating unit that, by inputting the speech of the user to a single model in which a group of parameters are learned simultaneously to output a response directly from a speech, generates a response to the speech.

### CROSS-REFERENCE TO RELATED APPLICATIONS

The present application claims priority to and incorporates by reference the entire contents of Japanese Patent Application No. 2017-052981 filed in Japan on Mar. 17, 2017.

### BACKGROUND OF THE INVENTION

### 1. Field of the Invention

The present invention relates to a generating device, a generating method, and a non-transitory computer readable storage medium.

### 2. Description of the Related Art

A technique of outputting a response to a speech of a user has conventionally been known. As one example of the technique, a technique of generating a interaction model by learning dialog data, and of generating a response to a speech of a user by using the generated interaction model has been known.

Japanese Laid-open Patent Publication No. 2013-105436.

“Sequence to Sequence Learning with Neural Networks” Ilya Dustcover, Oriol Vinyals, Quoc V. Le.

However, in the conventional technique described above, improvement of accuracy of responses can be difficult.

For example, in the conventional technique, voice recognition processing to convert a speech of a user into text, intention estimation processing to estimate an intention of the speech from the text, and response generation processing to generate a response based on the estimated intention are performed in a step-by-step manner, thereby generating a response to a speech. However, in such a conventional technique, if an error occurs in either processing, errors are accumulated in following processing, and an irrelevant response can be output.

### SUMMARY OF THE INVENTION

It is an object of the present invention to at least partially solve the problems in the conventional technology.

According to one aspect of an embodiment a generating device includes an accepting unit that accepts a speech of a user. The generating device includes a generating unit that, by inputting the speech of the user to a single model in which a group of parameters are learned simultaneously to output a response directly from a speech, generates a response to the speech.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating one example of processing that is performed by an information providing apparatus according to an embodiment;

FIG. 2 is a diagram illustrating a configuration example of the information providing apparatus according to the embodiment;

FIG. 3 is a diagram illustrating one example of an effect of the information providing apparatus according to the embodiment;

FIG. 4 is a flowchart of a flow example of generation processing that is performed by the information providing apparatus according to the embodiment; and

FIG. 5 is a diagram illustrating one example of a hardware configuration.

### DETAILED DESCRIPTION OF THE PREFERRED EMBODIMENTS

Forms (hereinafter, “embodiments”) to implement a generating device, a generating method, and a non-transitory computer readable storage medium according to the present application are explained in detail below, referring to the drawings. The embodiments are not intended to limit the generating device, the generating method, and the non-transitory computer readable storage medium according to the present application. Like reference symbols are assigned to like parts throughout the following embodiments, and duplicated explanation is omitted.

### 1-1. Outline of Information Providing Apparatus

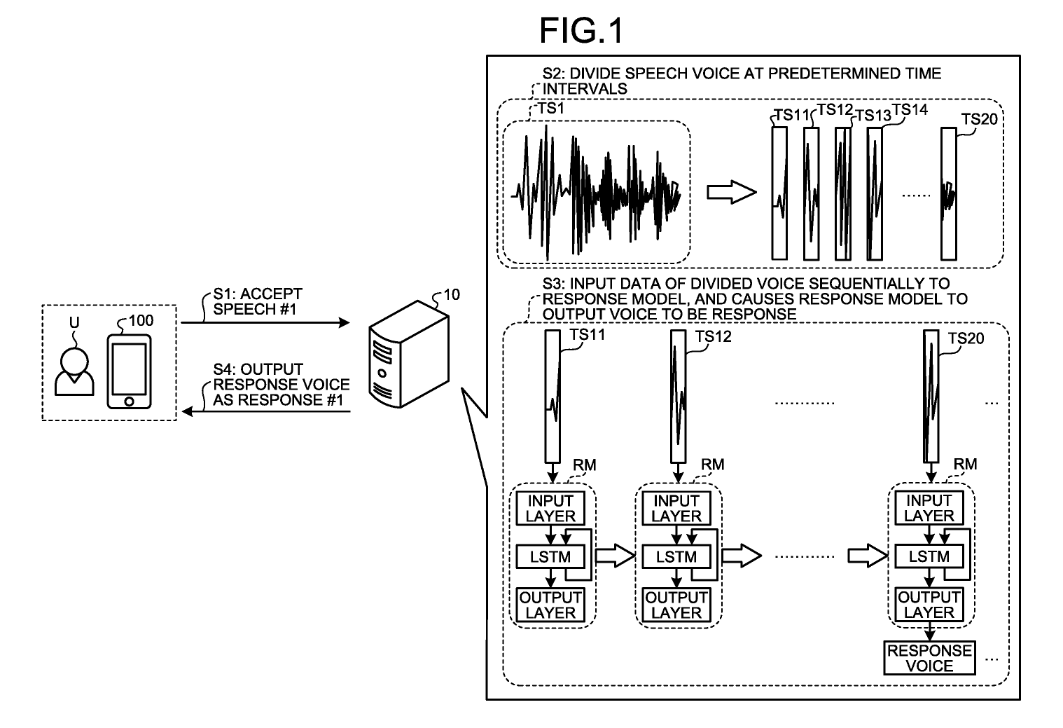

First, one example of generation processing that is performed by an image providing apparatus, which is one example of generation processing, is explained by using FIG. 1. FIG. 1 is a diagram illustrating one example of processing that is performed by the information providing apparatus according to an embodiment. In the following explanation, an example of processing of generating and outputting a response to a speech of a user U is explained as the processing performed by an information providing apparatus 10. That is, the information providing apparatus 10 is an interaction system that enables interaction with the user U.

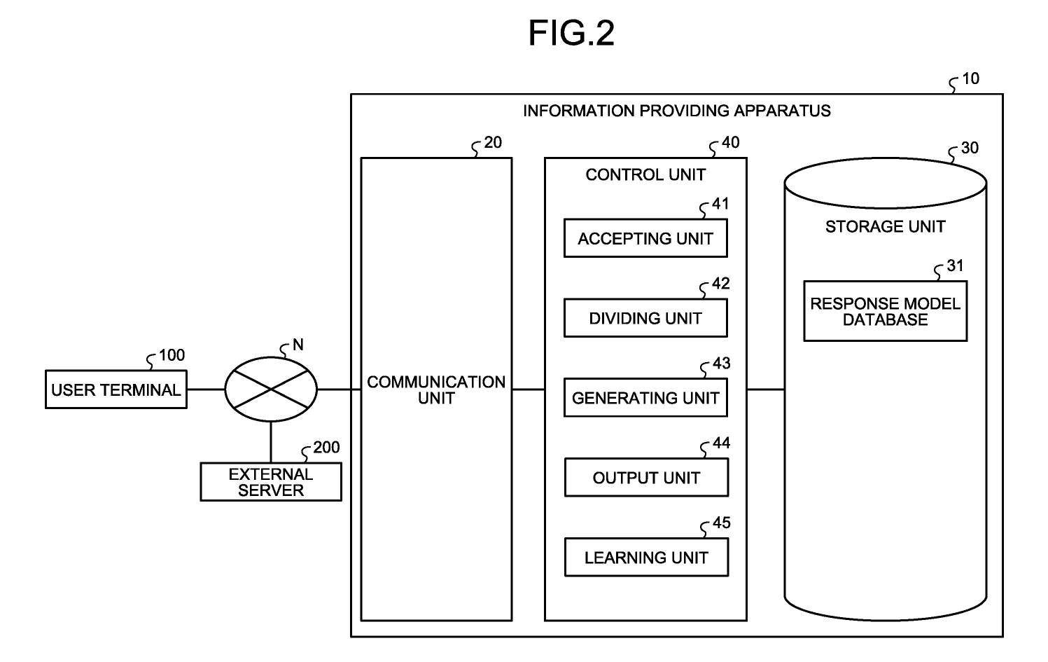

The information providing apparatus 10 is an information processing apparatus that can communicate with a user terminal 100 through a predetermined network N (for example, refer to FIG. 2), such as the Internet, and is implemented by, for example, a server device, a cloud system, or the like. The information providing apparatus 10 can be enabled to communicate with any number of the user terminal 100.

The user terminal 100 is an information processing apparatus that is used by the user U interacting therewith by an interaction system, and is implemented by an information processing apparatus, such as a personal computer (PC), a server device, and a smart device. For example, when acquiring voice spoken by the user U, the user terminal 100 transmits voice data to the information providing apparatus 10 as a speech. The user terminal 100 can transmit a character string input by the user U to the information providing apparatus 10 as a speech.

### 1-2. Generation Processing

In a conventional technique, a response to a speech of the user U is generated from the speech by performing multiple kinds of processing in a step-by-step manner. For example, in the conventional technique, voice recognition processing of analyzing voice data of a speech of a user to convert into text, intention analysis processing of analyzing an intention of the speech of the user by using the text obtained by the voice recognition processing, and response generation processing of generating a response by using the result of the intention analysis processing are performed, thereby generating a response to a speech.

That is, in the conventional technique, text or voice data to be a response is generated from a speech of the user U by performing response processing that includes multiple kinds of processing to be performed in a step-by-step manner, such as the voice recognition processing, the intention analysis processing, and the response generation processing, and the generated response is transmitted to the user terminal 100. Consequently, the user terminal 100 achieves interaction with the user U by a technique of reading various kinds of text generated as a response, or by reproducing voice data.

However, in the conventional technique as described above, improvement of accuracy of responses can be difficult. For example, in the conventional technique, if an error occurs in either processing, errors are accumulated in following processing, and an irrelevant response can be output.

Therefore, the information providing apparatus 10 performs generation processing as follows. The information providing apparatus 10 first accepts a speech of the user U. In this case, the information providing apparatus 10 inputs the speech of the user U to a single model in which a group of parameters are simultaneously learned to output a response directly from a speech, and generates a response to the speech.

That is, the information providing apparatus 10 generates an output from an input by using a single model serving a function that has been achieved by performing multiple kinds of processing in a step-by-step manner. For example, the information providing apparatus 10 uses a model (hereinafter, “response model”), such as a neural model, that has learned to output voice data to be a response when voice data as a speech is input. As a result, the information providing apparatus 10 can avoid accumulation of errors as for a function that is achieved by performing multiple kinds of processing in a step-by-step manner, and therefore, the accuracy of responses can be easily improved.

Moreover, for the function that is achieved by performing multiple kinds of processing in a step-by-step manner, a correction strategy whether to perform correction as the entire function, whether to perform correction per processing, or the like is important to improve the accuracy of outputs. For example, in the response processing of outputting a response to a speech of the user U, it is considered that the accuracy of a response can vary according to whether either model is to be corrected, or all the models are corrected at once when there is a voice recognition model to perform the voice recognition processing, an intension analysis model to perform the intention analysis processing, and a response generation model to perform the response generation processing independently.

For example, when an error occurs in the voice recognition model to perform the voice recognition processing, if all the models are re-learned at the same time, the processing accuracy of the intention analysis model and the response generation model with no errors can be degraded. Moreover, when an error related to linkage between the respective models occurs, learning to improve the linkage accuracy without degrading the processing accuracy of the models that have learned independently is necessary, and therefore, it takes time and effort for learning processing of all of the models.

On the other hand, the information providing apparatus 10 generates a response directly from a speech by using a single response model in which a group of parameters to implement one function (namely, the interaction processing) has been learned simultaneously. When this kind of model is used, in the case of occurrence of an error in a response, re-learning of the response model should be performed so as to avoid the error (for example, handling a response including the error as wrong data). As a result, the information providing apparatus 10 can simplify the learning processing, and can improve the accuracy of responses easily.

### 1-3. Models

The information providing apparatus 10 can adopt any model as the response model as long as the model in which a response is given directly from a speech. For example, the information providing apparatus 10 can use a recurrent neural network (RNN) or a convolutional neural network (CNN) as the response model, and the response model can learn such that voice data of a response is directly generated from voice data of a speech. Furthermore, the information providing apparatus 10 can use a model that holds information according to an input feature amount for a predetermined period, and outputs information based on a newly input feature amount and the information held, to generate a response. More specifically, the information providing apparatus 10 can use a response model that outputs voice data to be a response after receiving all of input voice data of accepted speech, to generate a response. This kind of response model can be implemented, for example, by the RNN (RNN-LSTM) that includes the long short-term memory (LSTM).

For example, the information providing apparatus 10 divides voice data of a speech accepted from the user U (hereinafter, “speech voice”) at predetermined time intervals. Subsequently, the information providing apparatus 10 generates a multidimensional amount (hereinafter, “feature amount”) that indicates features, such as frequency, fluctuations of frequency, and magnitude of voice (amplitude), for each piece of the divided speech voice, and inputs the generated feature amounts to the response model in order of appearance in speech voice. The information providing apparatus 10 can transmit voice that is output by the response model when all pieces of the divided speech voice are input to the user terminal 100 as voice data of a response (hereinafter, “speech voice”).

### 1-4. Example of Determination Processing

One example of processing that is performed by the information providing apparatus 10 is explained by using FIG. 1. First, the information providing apparatus 10 accepts a speech voice as a speech #1 from the user terminal 100 (step S1). In this case, the information providing apparatus 10 divides the speech voice at predetermined time intervals (step S2). For example, the information providing apparatus 10 generates speech voices TS11 to TS20 that are obtained by dividing the speech voice TS1 at predetermined time intervals.

Subsequently, the information providing apparatus 10 inputs pieces of data of the divided speech voice sequentially to the response model, and causes the response model to output a voice to be a response (step S3). For example, the information providing apparatus 10 inputs a feature amount of the speech voice TS11 to a response model RM. In the example illustrated in FIG. 1, the response model RM that has an input layer accepting a feature amount of a speech voice, the LSTM performing various kinds of processing based on an output from the input layer, and an output layer outputting a response voice based on an output from the LSTM is illustrated.

Subsequently, the information providing apparatus 10 inputs a feature amount of the speech voice TM12 to the response model RM. Thereafter, the information providing apparatus 10 inputs feature amounts of the other speech voices also to the response model RM sequentially, and finally inputs a feature amount of the speech voice TM20 to the response model RM. In this case, if learning of the response model RM has been appropriately performed, the response model RM outputs a response voice to the speech voice TS1. Therefore, the information providing apparatus 10 outputs the response voice output by the response model RM to the user terminal 100 as a response #1 to the speech #1 (step S4).

### 1-5. Learning of Response Model

The information providing apparatus 10 can perform any learning processing as long as various kinds of parameters (for example, a connection coefficient between nodes included in the response model) in the response model RM are learned simultaneously. For example, the information providing apparatus 10 acquires a set of a speech voice and a response voice to be output by the response model RM when the speech voice is input, as a correct pair. In this case, the information providing apparatus 10 performs processing such as backpropagation so that a response voice of a correct pair is output when a speech voice of the correct pair is input, thereby performing correction of parameters in the response model RM. That is, the information providing apparatus 10 can use any response model as long as it is a model constituted of a parameter group that can be a subject of correction using one learning data, and that is used as one model when processing is performed.

### 2. Configuration of Information Providing Apparatus

One example of a functional configuration of the information providing apparatus 10 described above is explained below. FIG. 2 is a diagram illustrating a configuration example of the information providing apparatus according to the embodiment. As illustrated in FIG. 2, the information providing apparatus 10 includes a communication unit 20, a storage unit 30, and a control unit 40.

The communication unit 20 is implemented, for example by a network interface card (NIC). The communication unit 20 is connected to the network N by wired or wireless connection, and communicates information with the user terminal 100.

The storage unit 30 is implemented, for example, by a semiconductor memory device, such as a random-access memory (RAM) and a flash memory, or a storage device, such as a hard disk and an optical disk. The storage unit 30 stores a response model database 31.

In the response model database 31, an RNN including an LSTM that is used as a response model is registered. For example, in the response model database 31, nodes in a neural network, information indicating connection relationship between nodes, and connection coefficients between connected nodes are registered in an associated manner.

The control unit 40 is a controller, and is implemented, for example, by executing various kinds of programs stored in the storage device in the information providing apparatus 10 by a processor, such as a central processing unit (CPU) and a micro processing unit (MPU), using a RAM or the like as a work area. Moreover, the control unit 40 is a controller, and can be implemented also by, for example, an integrated circuit, such as an application specific integrated circuit (ASIC) and a field programmable gate array (FPGA). As illustrated in FIG. 2, the control unit 40 includes an accepting unit 41, a dividing unit 42, a generating unit 43, an output unit 44, and a learning unit 45.

The accepting unit 41 accepts a speech of the user U. For example, the accepting unit 41 accepts voice that is spoken by the user U, that is a speech voice. In this case, the accepting unit 41 outputs the speech voice to the dividing unit 42.

The dividing unit 42 divides the speech voice at predetermined time intervals. For example, when accepting data of a speech voice, the dividing unit 42 divides the speech voice at predetermined time intervals (for example, 0.1 second). The dividing unit 42 then outputs the divided speech voices to the generating unit 43.

The generating unit 43 inputs the speech of the user U to a single model that has learned a group of parameters simultaneously so that a speech is directly output from a response, to generate a response to the speech. For example, the generating unit 43 generates a response to the speech by using a response model that has learned to output a response voice from a speech voice.

For example, the generating unit 43 reads the response model from the response model database 31. The generating unit 43 then inputs feature amount information that indicates a feature amount of the divided speech voice sequentially to the response model, and generates a response voice from the feature amount output by the response model. That is, the generating unit 43 uses a model that holds information according to an input feature amount for a predetermined period, and that outputs information based on a newly input feature amount and the held information as the response model, to output a response.

How a response voice is generated from information output by the response model can be arbitrarily set according to a learning mode of the response model. For example, when a feature amount of one speech voice is input, and if the response model has learned to output information indicating a feature amount (namely, a wavelength, a wavelength change, a sound level, and the like) of a response voice, the generating unit 43 can receive an input of a feature amount of the speech voice, and generate voice data of a response voice from a feature amount of the response voice output by the response model. Moreover, for example, when a wavelength of one speech voice is input, and if the response model has learned to output information indicating a wavelength of a response voice, the generating unit 43 can input a wavelength of a speech voice to the response model, and can generate voice data of a wavelength output by the response model.

Furthermore, when the response model has learned to output a response voice after all of divided speech voices are input, the generating unit 43 can acquire a response voice that is output by the response model after all of the divided speech voices are input. Moreover, when the response model has learned to sequentially output divide response voices each time a divided speech voice is input, the generating unit 43 can generate a response voice to provide to the user U by connecting response voices that are output by the response model each time a divided speech voice is input thereto. That is, the generating unit 43 can generate a response to a speech by using a model subjected to arbitrary learning, as long as a response voice is generated from a speech voice by using a parameter group that constitutes a model.

The output unit 44 outputs a response that is generated by the generating unit 43. For example, the output unit 44 transmits data of a response voice that is generated by the generating unit 43 by using the response model to the user terminal 100.

The learning unit 45 learns a group of parameters simultaneously to output a response directly from a speech. That is, the learning unit 45 performs learning of a parameter group included in the response model such that a response is output directly from a speech.

For example, the learning unit 45 acquires a pair of voice data of one speech and a response that is estimated to be appropriate for the speech as a correct pair from an external server 200 or the like as learning data. In this case, the learning unit 45 reads out the response model from the response model database 31, and performs learning of the response model to output voice data of a response included in a correct pair when voice data of a speech included in the correct pair is input. As for the learning of the response model, any learning method can be applied. Moreover, the learning unit 45 can divide voice data of a speech included in a correct pair, and can perform learning of the response model to output voice data of a response when pieces of the divided voice data are sequentially input, and can perform learning to output a piece of divided voice data of a response each time a piece of the divided voice data is input.

### 3. Generation Processing Performed by Information Providing Apparatus

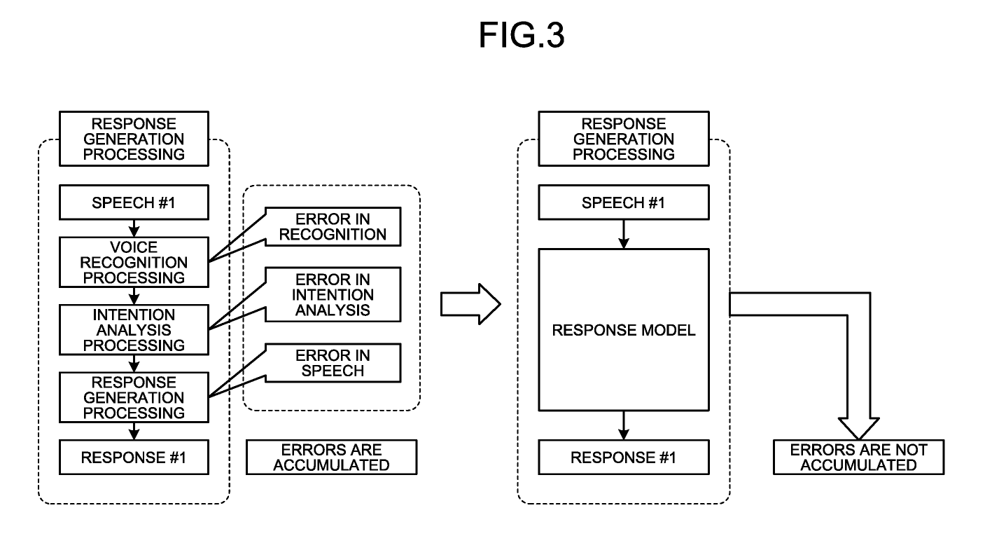

By the processing described above, the information providing apparatus 10 can avoid accumulation of errors caused by performing processing in a step-by-step manner. For example, FIG. 3 is a diagram illustrating one example of an effect of the information providing apparatus according to the embodiment. For example, as illustrated on a left side of FIG. 3, in the conventional generation processing, by performing the voice recognition processing, the intention analysis processing, and the response generation processing in a step-by-step manner the response #1 to the speech #1 is generated from the speech #1 of the user U. However, in this processing, when an error in recognition occurs in the voice recognition processing, when an error in intention analysis occurs in the intention analysis processing, or when an error in speech due to insufficient speech occurs in the response generation processing, a response is generated without correcting the error in processing in a subsequent stage, and therefore, the errors accumulate.

On the other hand, the information providing apparatus 10 generates the response #1 directly from the speech #1 by using the response model. As a result, even if an error occurs in the middle of the processing, errors are not accumulated, and a processing result estimated to be highly accurate in the entire processing to generate the response #1 from the speech #1 is output as the response #1. Moreover, the information providing apparatus 10 can perform learning of the response model to output an appropriate response from a speech. Therefore, the information providing apparatus 10 can improve the accuracy of responses easily.

### 4. One Example of Flow of Processing Performed by Information Providing Apparatus

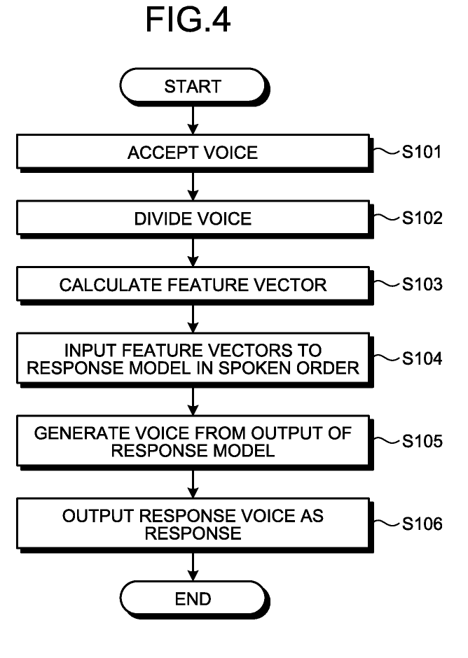

Subsequently, one example of a flow of the processing that is performed by the information providing apparatus 10 is explained using FIG. 4. FIG. 4 is a flowchart of a flow example of the generation processing that is performed by the information providing apparatus according to the embodiment.

For example, the information providing apparatus 10 accepts voice of a speech of the user U (step S101). In this case, the information providing apparatus 10 divides the voice (step S102), and calculates a feature vector of each piece of the divided voice (step S103). That is, the information providing apparatus 10 generates a multidimensional amount in which feature amounts of respective elements, such as a frequency, a frequency change, and a sound level, are put together of each piece of the divided voice. The information providing apparatus 10 then inputs the feature vector of the pieces of the divided voice to the response model sequentially in spoken order (step S104), to generate a voice from an output of the response model (step S105). Subsequently, the information providing apparatus 10 outputs the generated voice as a response voice (step S106), and ends the processing.

### 5. Modification

In the above, one example of determination processing and reinforcement learning by the information providing apparatus 10 has been explained. However, embodiments are not limited thereto. In the following, variations of provision processing or the determination processing performed by the information providing apparatus 10 are explained.

### 5-1. Application Target

In the example described above, the information providing apparatus 10 avoids accumulation of errors and facilitates learning by performing multiple kinds of processing that have been performed in a step-by-step manner when generating a response from a speech, with a single model. However, embodiments are not limited thereto. For example, the information providing apparatus 10 can perform processing using a single model as for any processing as long as multiple kinds of processing are performed in a step-by-step manner, such as image analysis and various kinds of authentication processing.

### 5-2. Apparatus Configuration

The information providing apparatus 10 can be implemented by a frontend server that communicates with the user terminal 100 and a backend server that performs the generation processing operating in cooperation. In this case, in the frontend server, the accepting unit 41 illustrated in FIG. 2 is provided, and in the backend server, the dividing unit 42, the generating unit 43, the output unit 44, and the learning unit 45 are provided.

### 5-3. Others

Out of the respective processing explained in the above embodiments, all or a part of the processing explained as performed automatically can be performed manually. To the contrary, all or a part of the processing explained as performed manually can be performed automatically by a publicly-known method. In addition, the processing procedure, specific names, information including various kinds of data and parameters that are indicated in the above document and the drawings can be changed arbitrarily unless otherwise specified. For example, the respective kinds of information illustrated in the respective drawings are not limited to the illustrated information.

Furthermore, the respective components of the respective devices illustrated are of functional concept, and it is not necessarily required to be configured physically as illustrated. That is, specific forms of distribution and integration of the respective devices are not limited to the ones illustrated, and all or a part thereof can be configured by distributing or integrating functionally or physically in arbitrary units according to various kinds of loads, usage patterns, and the like.

Moreover, the embodiments described above can be combined appropriately within a range not causing contradictions in the processing.

### 5-4. Program

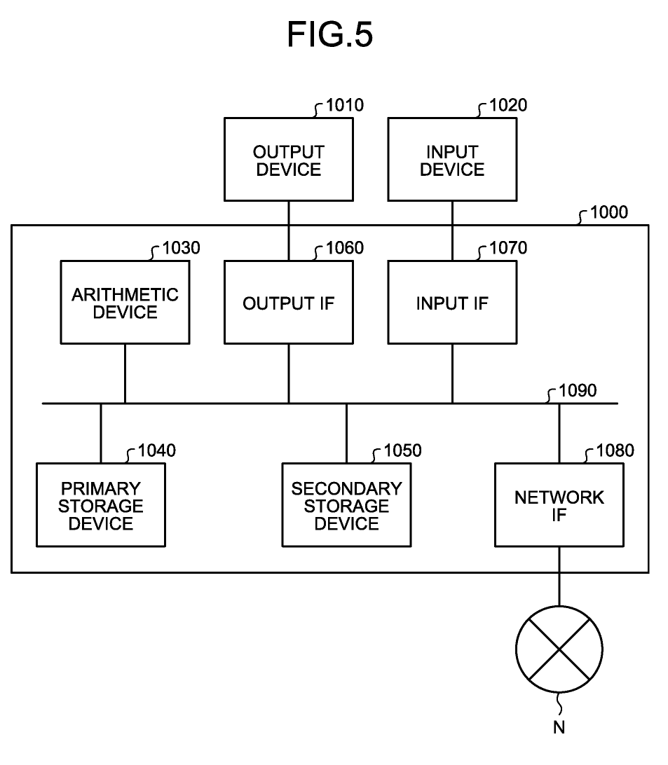

Furthermore, the information providing apparatus 10 according to the embodiment described above can be implemented by, for example, a computer 1000 having a configuration as illustrated in FIG. 5. FIG. 5 illustrates one example of a hardware configuration. The computer 1000 are connected to an output device 1010 and an input device 1020, and has a form in which an arithmetic device 1030, a primary storage device 1040, a secondary storage device 1050, an output interface (IF) 1060, an input IF 1070, and a network IF 1080 are connected by a bus 1090.

The arithmetic device 1030 operates based on a program stored in the primary storage device 1040 or the secondary storage device 1050, or a program read from the input device 1020 or the like, and performs various kinds of processing. The primary storage device 1040 is a memory device, such as a RAM, that temporarily stores data that is used for various kinds of arithmetic processing by the arithmetic device 1030. Moreover, the secondary storage device 1050 is a storage device that stores data used for various kinds of arithmetic processing by the arithmetic device 1030 and various kinds of databases, and is implemented by a read-only memory (ROM), a hard disk drive (HDD), a flash memory, or the like.

The output IF 1060 is an interface to transmit information that is a subject of output to the output device 1010 that outputs various kinds of information, such as a monitor and a printer, and is implemented, for example, by a connecter of a standard such as a universal serial bus (USB), a digital visual interface (DVI), and high definition multimedia interface (HDMI (registered trademark)). Furthermore, the input IF 1070 is an interface to receive information from various kinds of the input device 1020, such as a mouse, a keyboard, and a scanner, and is implemented, for example, by a USB or the like.

The input device 1020 can be a device that reads information from an optical recording medium, such as a compact disc (CD), a digital versatile disc (DVD), and a phase change rewritable disk (PD), a magneto-optical recording medium, such as a magneto-optical disk (MO), a tape medium, a magnetic recording medium, a semiconductor memory, or the like. Alternatively, the input device 1020 can be an external recording medium such as a USB memory.

The network IF 1080 receives data from other devices through the network N, transfers it to the arithmetic device 1030, and transmits data that is generated by the arithmetic device 1030 to another device through the network N.

The arithmetic device 1030 controls the output device 1010 and the input device 1020 through the output IF 1060 and the input IF 1070. For example, the arithmetic device 1030 loads a program from the input device 1020 or the secondary storage device 1050 onto the primary storage device 1040, and executes the loaded program.

For example, when the computer 1000 functions as the information providing apparatus 10, the arithmetic device 1030 of the computer 1000 implements the function of the control unit 40 by executing a program loaded onto the primary storage device 1040.

### 6. Effects

As described above, the information providing apparatus 10 accepts a speech of the user U. The information providing apparatus 10 then inputs the speech of the user U to a single model in which a group of parameters are simultaneously learned to output a response directly from a speech, to generate a response to the speech. Thus, the information providing apparatus 10 can avoid accumulation of errors, and can facilitates the learning of a model, and therefore, enables to improve the accuracy of responses easily.

Moreover, the information providing apparatus 10 accepts a voice spoken by the user U, and generates a response to the speech by using a model that has learned to output a voice of a response from the voice of the speech. Thus, the information providing apparatus 10 generates a response by using the response model that outputs a response voice directly from a speech voice, and therefore, enables to improve the accuracy of responses easily.

Furthermore, the information providing apparatus 10 divides an accepted voice at predetermined time intervals. The information providing apparatus 10 then sequentially inputs feature amount information that indicates respective feature amounts of pieces of the divided voice to the model, and generates a voice of a response from a feature amount output by the model. Therefore, the information providing apparatus 10 can implement generation of a response voice from a speech voice by using a single model.

Moreover, the information providing apparatus 10 generates a response by using a model that holds information according to an input feature amount and outputs information based on a newly input feature amount and the held information, as a model. For example, the information providing apparatus 10 uses a voice that is output by the model after all of the accepted voices are input, as a voice of response. Therefore, the information providing apparatus 10 can implement generation of an appropriate response voice from a speech voice.

As described above, embodiments of the present application have been explained in detail based on the drawings, but these are examples, and not only by the modes described in the section of disclosure of the invention, but also by other modes in which various modifications and improvements are made based on knowledge of a person skilled in the art, the present invention can be implemented.

Furthermore, “unit” described above can be replaced with “means” or “circuit”. For example, the generating unit can be replaced with an generating means or an generating circuit.

According to one aspect of the embodiments, the accuracy of responses can be easily improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A generating device comprising:
an accepting unit that accepts a speech of a user; and
a generating unit that, by inputting the speech of the user to a single model in which a group of parameters are learned simultaneously to output a response directly from a speech, generates a response to the speech.

2. The generating device according to claim 1, wherein
the accepting unit accepts a voice that is spoken by the user, and
the generating unit generates a response to the speech by using the model that has learned to output a voice of the response from a voice of the speech.

3. The generating device according to claim 2 further comprising
a dividing unit that divides a voice accepted by the accepting unit at predetermined time intervals, wherein
the generating unit inputs feature amount information that indicates feature amounts of pieces of the voice divided by the dividing unit sequentially to the model, and generates the voice of the response from a feature amount that is output by the model.

4. The generating device according to claim 3, wherein
the generating unit uses a model that holds information according to an input feature amount for a predetermined period, and that outputs information based on a newly input feature amount and the held information, to generate the response.

5. The generating device according to claim 4, wherein
the generating unit uses a voice that is output by the model after all of voices accepted by the accepting unit are input, as the voice of the response.

6. A generating method that is performed by a generating device, the method comprising:
accepting a speech of a user; and
by inputting the speech of the user to a single model in which a group of parameters are learned simultaneously to output a response directly from a speech, generating a response to the speech.

7. A non-transitory computer-readable recording medium having stored a generating program that causes a computer to execute a process comprising:
accepting a speech of a user; and
by inputting the speech of the user to a single model in which a group of parameters are learned simultaneously to output a response directly from a speech, generating a response to the speech.
